(19) United States
(12) Patent Application Publication
(10) Pub. No.: US 2024/0255784 A1
(43) Pub. Date: Aug. 1, 2024

(54) Optical Waveguide Device, and Optical Modulation Device and Optical Transmission Apparatus Using Same

(71) Applicant: SUMITOMO OSAKA CEMENT CO., LTD., Tokyo (JP)

(72) Inventors: Shotaro HIRATA, Tokyo (JP); Kosuke OKAHASHI, Tokyo (JP)

(73) Assignee: SUMITOMO OSAKA CEMENT CO., LTD., Tokyo (JP)

(21) Appl. No.: 18/518,311

(22) Filed: Nov. 22, 2023

(30) Foreign Application Priority Data
Jan. 30, 2023 (JP) 2023-011955

(51) Int. Cl. G02F 1/035

(52) U.S. Cl. CPC G02F 1/035

(57) ABSTRACT

An optical waveguide device includes an optical waveguide formed on a substrate, in which a protuberant portion is formed on a surface of the substrate, the optical waveguide is disposed on the protuberant portion and is formed to have a larger width than a width of a part of the protuberant portion, and a low refractive index layer is disposed to cover the optical waveguide and to be in contact with at least a part of the protuberant portion, and has a lower refractive index than the optical waveguide.

### BACKGROUND OF THE INVENTION

### Field of the Invention

The present invention relates to an optical waveguide device, and an optical modulation device and an optical transmission apparatus using the same, and particularly to an optical waveguide device including an optical waveguide formed on a substrate, and an optical modulation device and an optical transmission apparatus using the same.

### Description of Related Art

In the field of optical measurement technology or in the field of optical communication technology, particularly in high-frequency/large-capacity optical fiber communication systems, an optical transmission apparatus incorporating an optical modulator configured with an optical waveguide device including an optical waveguide formed on a substrate has been widely used. In recent years, a high frequency and a large capacity of optical communication used in a long distance or between cities or data centers have been desired in accordance with an increase in information amount. In addition, the optical modulator is also required to achieve a high frequency and size reduction because of restrictions caused by a space of a base station.

In achieving size reduction of the optical waveguide device such as the optical modulator, strengthening a confining effect of light can decrease a bending radius of the optical waveguide and achieve size reduction. Thus, forming a micro-optical waveguide is effective. For example, LiNbO₃ (hereinafter, referred to as LN) having an electro-optic effect has small distortion and a low optical loss in converting an electrical signal into an optical signal and thus, has been used as a long-distance optical modulator. In the LN optical modulator, the optical waveguide in the related art has a mode field diameter (MFD) of approximately 10 μmφ and a bending radius of several tens of mmφ, which is large. Thus, it is difficult to achieve size reduction.

Recently, improvement in polishing technology and bonding technology has enabled achieving a thin plate of the LN substrate, and research to develop on a LN optical waveguide of approximately 1 μmφ has been carried out. Meanwhile, an MFD of an optical fiber is 3 μmφ, and in an optical waveguide device including a micro-optical waveguide having an MFD smaller than the MFD of the optical fiber, a significant insertion loss occurs in the case of inputting light from a device end surface when the optical fiber is directly joined. Thus, as illustrated in Japanese Laid-open Patent Publication No. 2021-162634, providing a spot size converter in which a low refractive index layer and a LN layer are combined with each other within a chip has been reviewed.

FIG. 1 is an optical waveguide device including an optical waveguide 10 formed on a substrate 1. The optical waveguide 10 is, for example, a rib type waveguide in which roughness is formed on a surface of the substrate 1. A low refractive index layer 2 (a permanent resist, a Si₂ layer, or the like) is disposed to cover the optical waveguide 10. The low refractive index layer 2 has a lower refractive index than the optical waveguide 10 and is formed of a transparent material. Thus, an effect of suppressing scattering of a light wave caused by degradation of a surface of the rib type waveguide is expected. In addition, a spot size converter SSC is disposed in an end portion of the optical waveguide 10.

While input light L1 and output light (L21, L22) are configured to be positioned on the same side surface of the substrate 1 in FIG. 1, the input light L1 and the output light (L21, L22) can also be configured to be positioned on side surfaces on which the input light and reflected light face each other.

An enlarged view of the spot size converter SSC illustrated by a dotted line frame X in FIG. 1 is illustrated in FIG. 2. FIG. 2 is a plan view illustrating an example of the spot size converter SSC. Cross section views along dot-dashed lines III-III and IV-IV are illustrated in FIG. 3 and FIG. 4, respectively. The substrate 1 on a lower side of the rib type waveguide is also formed to have a tapered shape in accordance with a tip end of the rib type waveguide, which is the optical waveguide 10, that is formed to have a tapered shape. In addition, a width of the low refractive index layer 2 covering the optical waveguide is also formed to be a gradually narrowed width. As the substrate, a substrate in which a thin plate of LN or the like is directly joined onto a holding substrate 3 or a substrate in which the holding substrate 3 is laminated with a LN layer is used. A desired MFD for the MFD in the spot size converter can be obtained by adjusting the width of the low refractive index layer 2. Consequently, adjusting an MFD of an end portion of the spot size converter can reduce an optical insertion loss. As illustrated in FIG. 3, in a case where joining strength between the low refractive index layer and the optical waveguide 10 (or the substrate 1) is low, adhesion between the low refractive index layer and the optical waveguide 10 is decreased as the width of the low refractive index layer is narrowed, and peeling or cracking of the low refractive index layer 2 occurs.

FIG. 5 is an enlarged view of the optical waveguide in a dotted line frame Y in FIG. 1. A cross section along dot-dashed line VI-VI is illustrated in FIG. 6. While a case where the width of the low refractive index layer 2 covering the optical waveguide 10 is wide rarely poses a problem, disposing the low refractive index layer only near the optical waveguide 10 poses the problem of peeling of the low refractive index layer 2, as in the case of the spot size converter. A member of reference sign 11 disposed on both sides of FIG. 5 illustrates a part of the substrate 1 left in a case where the optical waveguide 10 is formed.

### SUMMARY OF THE INVENTION

An object to be solved by the present invention is to solve the above problem and to provide an optical waveguide device in which peeling of a low refractive index layer covering an optical waveguide is prevented even in a case where a width of the low refractive index layer is narrowed. Furthermore, an optical modulation device and an optical transmission apparatus using the optical waveguide device are provided.

In order to solve the object, an optical waveguide device of the present invention, and an optical modulation device and an optical transmission apparatus using the same have the following technical features.

(1) An optical waveguide device includes an optical waveguide formed on a substrate, in which a protuberant portion is formed on a surface of the substrate, the optical waveguide is disposed on the protuberant portion and is formed to have a larger width than a width of a part of the protuberant portion, and a low refractive index layer is disposed to cover the optical waveguide and to be in contact with at least a part of the protuberant portion, and has a lower refractive index than the optical waveguide.

(2) In the optical waveguide device according to (1), a width of the low refractive index layer may be 5 μm or lower.

(3) In the optical waveguide device according to (2), the low refractive index layer may constitute a part of a spot size converter of the optical waveguide.

(4) In the optical waveguide device according to (1), recess portions may be formed on both sides of the protuberant portion, and the low refractive index layer may be disposed to be in contact with the recess portions.

(5) In the optical waveguide device according to (1), a refractive index of the protuberant portion may be lower than the refractive index of the optical waveguide.

(6) In the optical waveguide device according to (1), the substrate may include a holding substrate and a thin film layer formed on the holding substrate, and the protuberant portion may be formed in the thin film layer.

(7) An optical modulation device includes the optical waveguide device according to (1), a case accommodating the optical waveguide device, and an optical fiber through which a light wave is input into the optical waveguide or output from the optical waveguide.

(8) In the optical modulation device according to (7), a control electrode (not illustrated) may be a modulation electrode for modulating the light wave propagating through the optical waveguide, and an electronic circuit that amplifies a modulation signal to be input into the modulation electrode may be provided inside the case.

(9) An optical transmission apparatus includes the optical modulation device according to (8), a light source that inputs a light wave into the optical modulation device, and an electronic circuit that outputs a modulation signal to the optical modulation device.

In the present invention, an optical waveguide device includes an optical waveguide formed on a substrate, in which a protuberant portion is formed on a surface of the substrate, the optical waveguide is disposed on the protuberant portion and is formed to have a larger width than a width of a part of the protuberant portion, and a low refractive index layer is disposed to cover the optical waveguide and to be in contact with at least a part of the protuberant portion, and has a lower refractive index than the optical waveguide. Thus, an area of contact between the optical waveguide and the low refractive index layer can be increased, and adhesion between both of the optical waveguide and the low refractive index layer can be increased. In addition, the low refractive index layer is disposed to surround a lower surface side of the optical waveguide, thereby exhibiting an anchoring effect, and peeling of the low refractive index layer can be effectively suppressed.

Furthermore, the optical waveguide device having such advantageous characteristics can also be used to provide an optical modulation device and an optical transmission apparatus that achieve the same effect.

### BRIEF DESCRIPTION OF THE DRAWINGS

FIG. 1 is a plan view illustrating an example of an optical waveguide device.

FIG. 2 is a plan view illustrating an example of a spot size converter in a dotted line frame X in FIG. 1.

FIG. 3 is a cross section view taken along dot-dashed line III-III in FIG. 2, illustrating a related art example.

FIG. 4 is a cross section view taken along dot-dashed line IV-IV in FIG. 2, illustrating the related art example.

FIG. 5 is a plan view illustrating an example of an optical waveguide in a dotted line frame Y in FIG. 1.

FIG. 6 is a cross section view taken along dot-dashed line VI-VI in FIG. 5, illustrating the related art example.

FIG. 7 is a cross section view taken along dot-dashed line VII-VII in FIG. 2, illustrating an example of an optical waveguide device of the present invention.

FIG. 8 is a cross section view taken along dot-dashed line VIII-VIII in FIG. 2, illustrating an example of the optical waveguide device of the present invention.

FIG. 9 is a cross section view taken along dot-dashed line IX-IX in FIG. 5, illustrating an example of the optical waveguide device of the present invention.

FIG. 10 is a cross section view illustrating a second example of the optical waveguide device of the present invention.

FIG. 11 is a cross section view illustrating a third example of the optical waveguide device of the present invention.

FIG. 12 is a cross section view illustrating a fourth example of the optical waveguide device of the present invention.

FIG. 13 is a cross section view illustrating a fifth example of the optical waveguide device of the present invention.

FIG. 14 is a cross section view taken along dot-dashed line XIV-XIV in FIG. 2, illustrating an example of the optical waveguide device of the present invention.

FIG. 15 is a cross section view illustrating a sixth example of the optical waveguide device of the present invention.

FIG. 16 is a plan view illustrating a seventh example of the optical waveguide device of the present invention.

FIG. 17 is a cross section view taken along dot-dashed line XVII-XVII in FIG. 16.

FIG. 18 is a diagram for describing a size of each part in the example illustrated in FIG. 11.

FIG. 19 is a diagram illustrating an example of an optical transmission apparatus of the present invention.

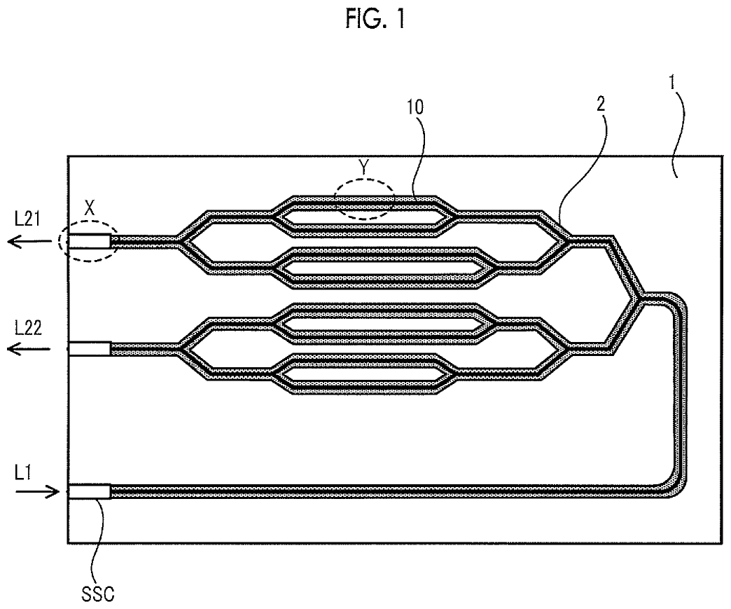

### DETAILED DESCRIPTION OF THE INVENTION

Hereinafter, an optical waveguide device of the present invention will be described in detail using preferred examples.

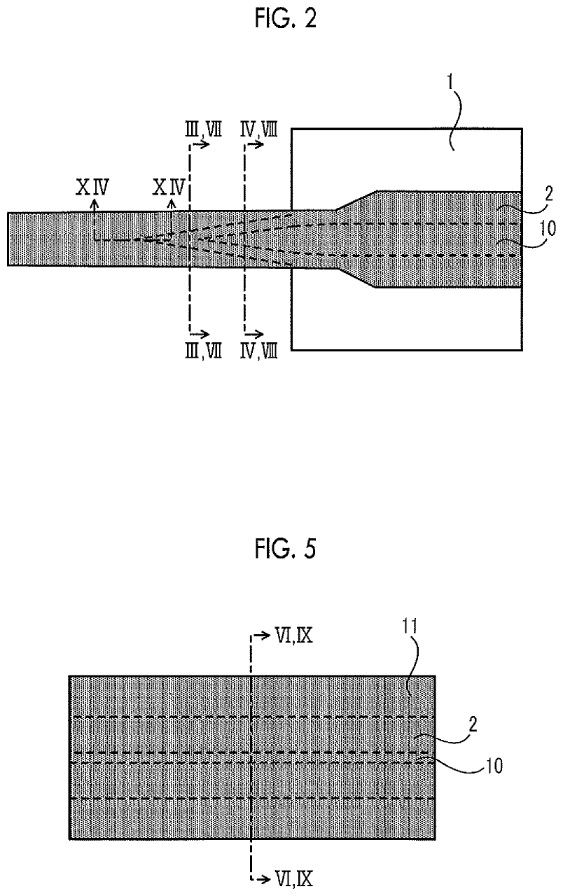

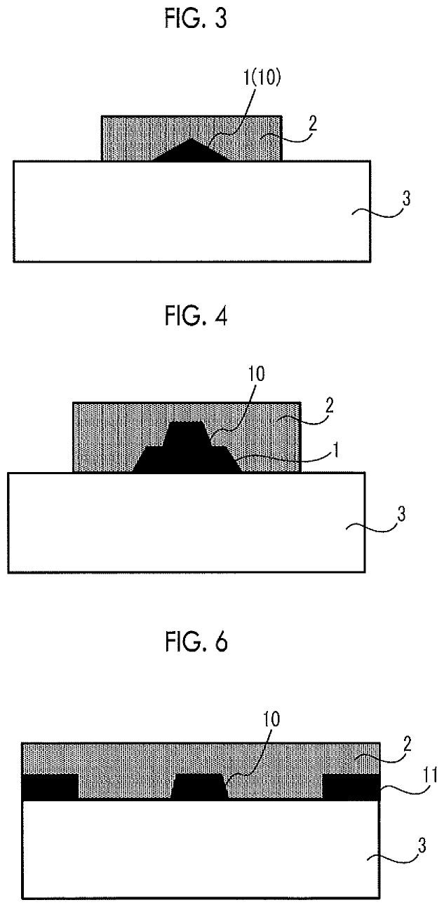

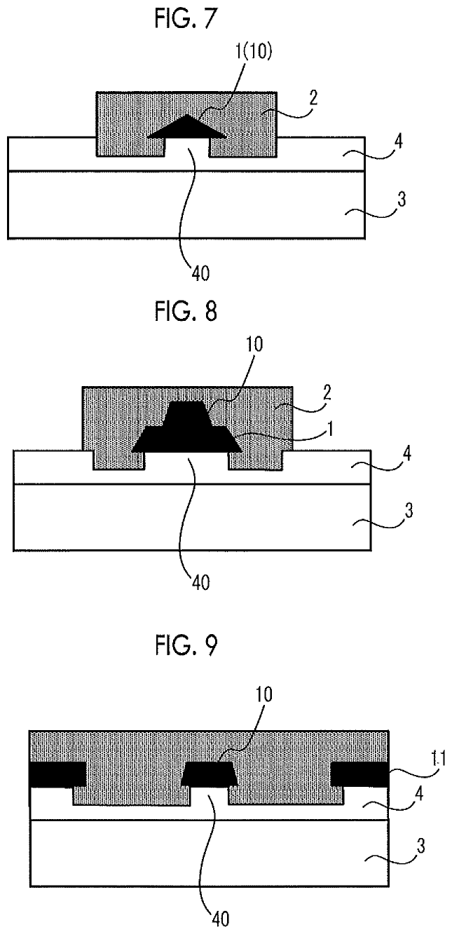

A cross section view illustrating an example of the optical waveguide device of the present invention is illustrated in FIGS. 7 to 9. FIG. 7 is a cross section view corresponding to dot-dashed line VII-VII in FIG. 2, FIG. 8 is a cross section view corresponding to dot-dashed line VIII-VIII in FIG. 2, and FIG. 9 is a cross section view corresponding to dot-dashed line IX-IX in FIG. 5.

An optical waveguide device of the present invention is an optical waveguide device including an optical waveguide 10 formed on a substrate, in which a protuberant portion 40 is formed on a surface of the substrate, the optical waveguide 10 is disposed on the protuberant portion and is formed to have a larger width than a width of a part of the protuberant portion, and a low refractive index layer 2 is disposed to cover the optical waveguide and to be in contact with at least a part of the protuberant portion, and has a lower refractive index than the optical waveguide.

As the substrate used in the optical waveguide device of the present invention, a substrate having an electro-optic effect can be used. Specifically, substrates of lithium niobate (LN), lithium tantalate (LT), lead lanthanum zirconate titanate (PLZT), and the like or base materials obtained by doping these substrate materials with MgO or the like can be used. In addition, these materials can be formed into films using a vapor-phase growth method such as a sputtering method, a vapor deposition method, or a CVD method. In addition, a substrate (thin plate) obtained by joining the substrate having the electro-optic effect to another substrate and then processing the electro-optical substrate into a thin film can be used. Furthermore, a semiconductor substrate, a substrate of an organic material such as EO polymer, and the like can also be used.

In the substrate 1 on which the optical waveguide is formed, a holding substrate is joined to a lower side of the substrate 1 in order to increase mechanical strength. The substrate 1 and a holding substrate 3 are adhesively fixed via direct joining or through an adhesive layer of resin or the like. The holding substrate to be directly joined preferably has, but is not limited to, a lower refractive index than the optical waveguide or than the substrate on which the optical waveguide is formed. In direct joining, a thin film of SiO₂ or the like may be formed on an interface to be joined, as necessary.

In a case where the refractive index of the holding substrate is higher than the refractive index of the substrate 1, a layer having a lower refractive index than the substrate 1 is provided between the substrate 1 and the holding substrate. In addition, a substrate including a material, for example, an oxide layer of crystal or of glass, having a similar coefficient of thermal expansion to the substrate 1 is preferably used as the holding substrate. Furthermore, the same LN substrate as the substrate 1, a silicon substrate, and furthermore, a composite substrate obtained by forming a silicon oxide layer on a silicon substrate and a composite substrate obtained by forming a silicon oxide layer on a LN substrate, which are abbreviated to SOI and LNOI, can also be used.

The “substrate” in the present invention not only means only the substrate 1 on which the optical waveguide is formed. The above holding substrate or a layer forming a protuberant portion, described later, is also referred to as the “substrate” in a case where the substrate 1 is configured as a thin plate or as a thin film.

As a method of forming the optical waveguide 10, a rib type waveguide obtained by forming a part corresponding to the optical waveguide to have a protruding shape in the substrate by, for example, etching the substrate 1 other than the optical waveguide or by forming grooves on both sides of the optical waveguide can be used. Furthermore, a refractive index can be further increased by diffusing Ti or the like on the surface of the substrate using a thermal diffusion method, a proton exchange method, or the like in accordance with the rib type optical waveguide. The rib type waveguide has a micro shape having a width and a height of approximately 1 μm as a size in order to increase confinement of light. The optical waveguide 10 may be a channel type waveguide obtained by completely removing the substrate 1 other than the optical waveguide or may be a rib type waveguide obtained by leaving a part of the substrate 1. In description of the “rib type” in the present invention, the channel type is also referred to as the “rib type”.

A shape of a cross section of the optical waveguide can employ various shapes such as a quadrangular shape, a trapezoidal shape, a triangular shape, and a semicircle of the rib type. For example, in a case where two angles of a bottom side of a triangular waveguide are smaller than 90 degrees as illustrated in FIG. 7, the triangular shape is large in a horizontal direction. Thus, it is easy to hold a TE mode.

In the case of applying an electric field to the optical waveguide 10 such as an optical modulator, a control electrode (not illustrated) is formed on the optical waveguide 10 or near the optical waveguide 10. The control electrode includes a modulation electrode that applies a modulation signal to the optical waveguide, and a DC bias electrode that applies a DC bias voltage to the optical waveguide. As a method of forming the control electrode, a base electrode is formed using the sputtering method, the vapor deposition method, or the like, and then the base electrode is formed into a thick electrode using a plating method.

A feature of the optical waveguide device of the present invention is formation of the optical waveguide 10 on the protuberant portion 40, as illustrated in FIGS. 7 to 9. Configuring a width of the optical waveguide 10 to be larger than a width of a part of the protuberant portion 40 can increase adhesion between the optical waveguide and the low refractive index layer covering the optical waveguide and furthermore, generate an anchoring effect from a combination of the optical waveguide and the protuberant portion.

A thin film layer of SiO₂ or the like can be used as a thin film layer 4 that forms the protuberant portion 40. In forming the protuberant portion 40, a thin film layer as the protuberant portion is formed, and then a thin plate or a thin film layer as the optical waveguide is formed to form the optical waveguide 10. Then, the protuberant portion 40 is formed in the thin film layer 4 via wet etching or the like. Thus, any material (for example, SiO₂ or Al₂O₃) having a higher etching speed and a lower refractive index than a material constituting the optical waveguide can be used as a material of the thin film layer 4.

A refractive index of a material constituting the protuberant portion is preferably lower than the refractive index of the material constituting the optical waveguide 10. In addition, in a case where the low refractive index layer 2 constitutes a part of a core portion of a spot size converter, a refractive index of the thin film layer 4 constituting the protuberant portion is more preferably a lower refractive index than the low refractive index layer 2. Of course, the thin film layer 4 may have a higher refractive index than the low refractive index layer 2 in other than the spot size converter.

A permanent resist obtained by leaving a part of a resin material such as a photoresist on the substrate is suitably used as the low refractive index layer 2 disposed to cover the optical waveguide. Novolac resin used in the photoresist can be used. The low refractive index layer 2 preferably has a lower refractive index than the optical waveguide 10, high transparency, and an effect of suppressing scattering of propagating light caused by roughness of a surface of the optical waveguide 10. In addition, a material that has fluidity to enter into a gap formed by the protuberant portion 40 and that almost does not have expansion caused by curing or has little contraction is preferred.

Generally, as a width of the low refractive index layer 2 is narrowed, the adhesion between the low refractive index layer 2 and the substrate including the optical waveguide 10 is decreased. Particularly, in a case where the width of the optical waveguide 10 is set to approximately 1 μm, setting the width of the low refractive index layer 2 to several times the width of the optical waveguide 10, for example, 5 μm or lower, decreases the adhesion between the optical waveguide and the low refractive index layer, and this easily causes peeling during a manufacturing process or use of the optical waveguide device. Particularly, in the case of using the low refractive index layer 2 in the spot size converter, since the low refractive index layer itself constitutes a part of the optical waveguide, the low refractive index layer is set to have a width of, for example, 5 μm or lower or furthermore, 3 μm or lower in accordance with an MED. The present invention is not only used for the low refractive index layer of the spot size converter but also can be suitably used for a part in which the width of the low refractive index layer is narrowed in the low refractive index layer covering the optical waveguide 10.

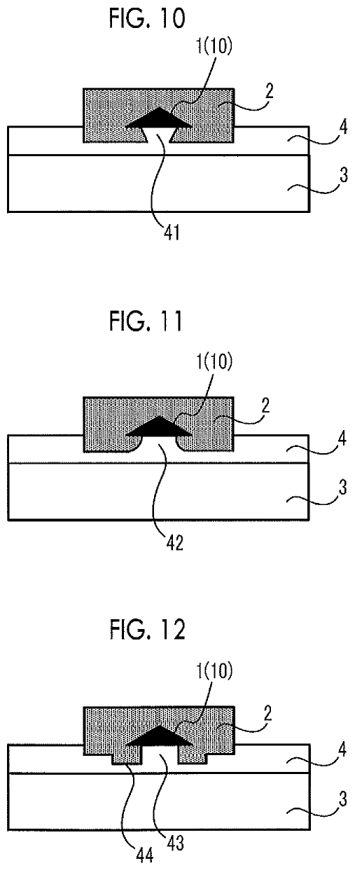

FIGS. 10 to 13 illustrate other examples in the optical waveguide part illustrated in FIG. 7.

In FIG. 10, a side surface of a protuberant portion 41 has a shape of inverted “trapezoid legs”. In FIG. 11, a side surface of a protuberant portion 42 has a shape of curved “trapezoid legs”, and a part of the protuberant portion is formed to be narrowed. In the optical waveguide device in FIG. 10 and FIG. 11, an area of contact with the low refractive index layer is increased, and the anchoring effect is also increased, compared to the optical waveguide device of a constant width illustrated in FIG. 7.

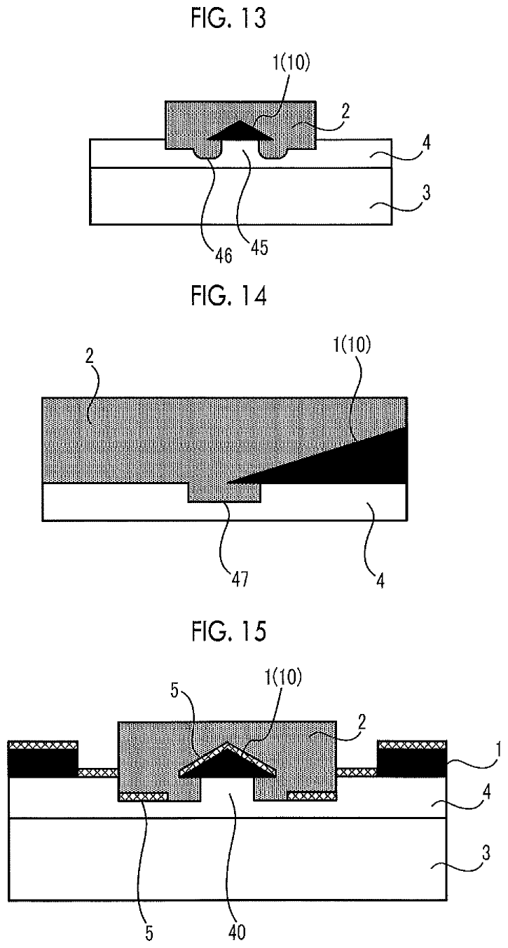

In FIG. 12, recess portions 44 are formed on both sides of a protuberant portion 43, and the low refractive index layer 2 is disposed to be in contact with the recess portions. In addition, in FIG. 13, recess portions 46 are formed on both sides of the protuberant portion 45, and inner surfaces of the recess portions 46 are configured as curved surfaces. The recess portions (44, 46) as in FIG. 12 and FIG. 13 can further increase the area of contact with the low refractive index layer 2. In addition, as illustrated in FIG. 13, by configuring the inner surfaces of the recess portions as curved surfaces, the low refractive index layer 2, for example, can alleviate generation of internal stress caused by contraction or expansion during thermal curing.

FIG. 14 is a cross section view taken along dot-dashed line XIV-XIV in FIG. 2. By forming a recess portion 47 in accordance with the protuberant portion even in a tip end part of a tapered shape, peeling of the low refractive index layer 2 in an end portion of the optical waveguide 10 (substrate 1) can be suppressed.

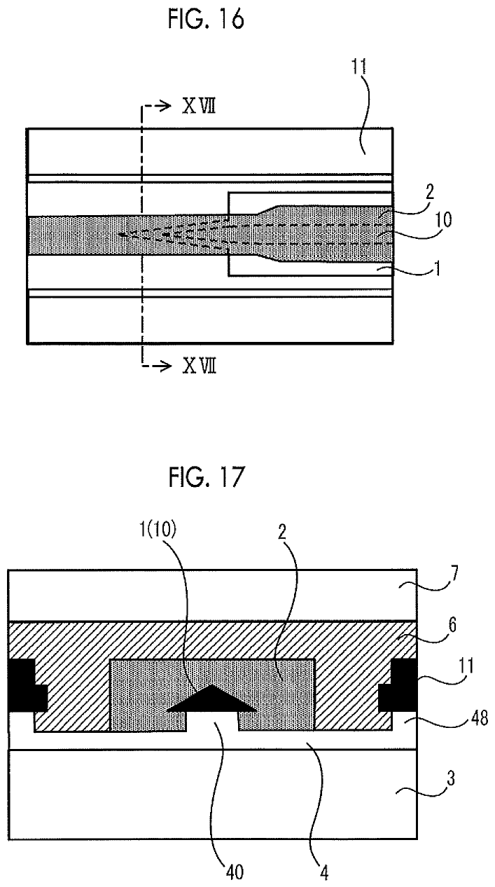

In FIG. 15, a SiO₂ film is disposed on a part (mainly an upper side part) of the optical waveguide 10 as a scattering suppression film 5, and the low refractive index layer 2 is disposed to cover the scattering suppression film 5. While adhesion between the scattering suppression film 5 formed of SiO₂ and the low refractive index layer configured with the permanent resist are bad, peeling of the low refractive index layer 2 can be suppressed by the anchoring effect since the low refractive index layer is disposed to cover the optical waveguide 10 and the protuberant portion 40.

FIG. 16 and FIG. 17 are diagrams for describing a state of adhesion of a reinforcing member disposed near the end portion of the substrate. FIG. 17 illustrates a cross section view taken along dot-dashed line XVII-XVII in FIG. 16. The low refractive index layer 2 covering the optical waveguide 10 is disposed, and a reinforcing member 7 is disposed on the low refractive index layer 2 through an adhesive layer 6. By leaving a part 11 of a LN layer to interpose the spot size converter in the part 11 and providing a protuberant portion 48 to enter inside the LN layer in a lower portion of the LN layer 11 using the thin film layer 4, not only an area of contact between the adhesive layer 6 and the thin film layer 4 is increased, but also peeling of the adhesive layer can be prevented by the anchoring effect of the LN layer 11.

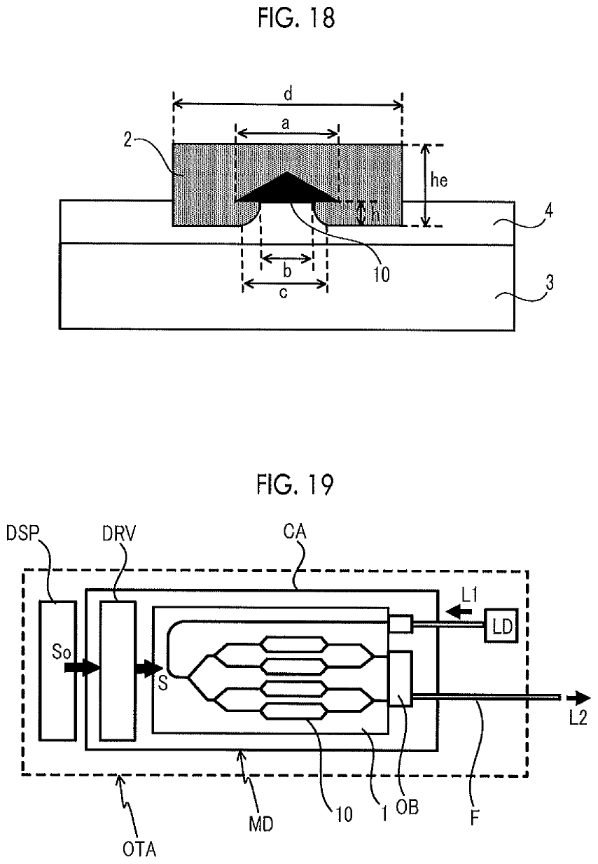

FIG. 18 is a diagram illustrating dimensions of each portion with reference to the example illustrated in FIG. 11. The dimensions are appropriately adjusted with a size of the optical waveguide device itself, a shape of the optical waveguide formed on the substrate, or the like. Particularly, in the spot size converter, the width of the optical waveguide 10 or the like varies depending on a location. Thus, the dimensions of each part have a certain range.

For example, a width a of the optical waveguide 10 is 3 μm or lower in other than the spot size converter and is normally set to approximately 1 μm. In the spot size converter, the width a of the optical waveguide 10 configured with the LN layer or the like changes within a range of 3 μm or lower or more preferably 1 μm or lower.

A width d of the low refractive index layer 2 covering the optical waveguide 10 is appropriately set within a range of 4 to 50 μm in other than the spot size converter. A height he is set to approximately 2 to 5 μm. However, in the case of using the low refractive index layer 2 as a part constituting the spot size converter, the low refractive index layer 2 is set to have a height of, for example, approximately 3 μm in accordance with a height of the part. The width d of the low refractive index layer 2 in the spot size converter is set within a range of 1 to 10 μm depending on a location of use. Particularly, in a case where the width d is 5 μm or lower, a configuration using the protuberant portion of the present invention is essential in order to prevent peeling of the low refractive index layer 2.

The thin film layer 4 constituting the protuberant portion is set to a thickness of, for example, 5 μm or lower considering a height h of the protuberant portion. The protuberant portion may have any height with which the gap into which the permanent resist of the low refractive index layer 2 enters can be secured. The height of the protuberant portion is set within a range of, for example, 10 to 500 nm.

As a shape of the protuberant portion, a ratio b/a of a width b of a top portion of the protuberant portion to the width a of the optical waveguide is preferably set to 90% or lower to generate the anchoring effect. In addition, to stably support the optical waveguide 10 via the protuberant portion, a ratio c/b of a width c of a bottom portion of the protuberant portion is 100% or higher, and a ratio c/a is also preferably 100% or higher.

Next, examples of applying the optical waveguide device of the present invention to an optical modulation device and to an optical transmission apparatus will be described. While an example of a high bandwidth-coherent driver modulator (HB-CDM) will be used in the following description, the present invention is not limited to the example and can also be applied to an optical phase modulator, an optical modulator having a polarization combining function, an optical waveguide device in which a larger or smaller number of Mach-Zehnder type optical waveguides are integrated, a device joined to an optical waveguide device including other materials such as silicon, a device used as a sensor, and the like.

As illustrated in FIG. 19, the optical waveguide device includes the optical waveguide 10 formed on the optical waveguide substrate 1, and the control electrode (not illustrated) such as the modulation electrode that modulates the light wave propagating through the optical waveguide 10. The optical waveguide device is accommodated inside a case CA. Furthermore, an optical modulation device MD can be configured by providing an optical fiber (F) through which the light wave is input into the optical waveguide or output from the optical waveguide. In FIG. 19, the optical fiber F is optically coupled to the optical waveguide 10 inside the optical waveguide device using an optical block including an optical lens, a lens barrel, a polarization combining unit OB, and the like. The present invention is not limited to the optical fiber F in FIG. 19. The optical fiber may be introduced into the case through a through-hole that penetrates through a side wall of the case. The optical fiber may be directly joined to an optical component or to the substrate, or the optical fiber having a lens function in an end portion of the optical fiber may be optically coupled to the optical waveguide inside the optical waveguide device. In addition, a reinforcing member (not illustrated) can be disposed to overlap along an end surface of the optical waveguide substrate 1 in order to stably join the optical fiber or the optical block.

An optical transmission apparatus OTA can be configured by connecting, to the optical modulation device MD, an electronic circuit (digital signal processor DSP) that outputs a modulation signal So causing the optical modulation device MD to perform a modulation operation. In order to obtain a modulation signal S to be applied to the optical waveguide device, it is required to amplify the modulation signal So output from the digital signal processor DSP. Thus, in FIG. 19, the modulation signal is amplified using a driver circuit DRV. The driver circuit DRV and the digital signal processor DSP can be disposed outside the case CA or can be disposed inside the case CA. Particularly, disposing the driver circuit DRV inside the case can further reduce a propagation loss of the modulation signal from the driver circuit.

While input light L1 of the optical modulation device MD may be supplied from an outside of the optical transmission apparatus OTA, a semiconductor laser (LD) can also be used as a light source as illustrated in FIG. 19. Output light L2 modulated by the optical modulation device MD is output to the outside through the optical fiber F.

As described above, according to the present invention, it is possible to provide an optical waveguide device in which peeling of a low refractive index layer covering an optical waveguide is prevented even in a case where a width of the low refractive index layer is narrowed. Furthermore, it is possible to provide an optical modulation device and an optical transmission apparatus using the optical waveguide device.

What is claimed is:

1. An optical waveguide device comprising an optical waveguide formed on a substrate, wherein
a protuberant portion is formed on a surface of the substrate;
the optical waveguide is disposed on the protuberant portion and is formed to have a larger width than a width of a part of the protuberant portion; and
a low refractive index layer is disposed to cover the optical waveguide and to be in contact with at least a part of the protuberant portion, and has a lower refractive index than the optical waveguide.

2. The optical waveguide device according to claim 1,
wherein a width of the low refractive index layer is 5 μm or lower.

3. The optical waveguide device according to claim 2,
wherein the low refractive index layer constitutes a part of a spot size converter of the optical waveguide.

4. The optical waveguide device according to claim 1,
wherein recess portions are formed on both sides of the protuberant portion, and the low refractive index layer is disposed to be in contact with the recess portions.

5. The optical waveguide device according to claim 1,
wherein a refractive index of the protuberant portion is lower than the refractive index of the optical waveguide.

6. The optical waveguide device according to claim 1,
wherein the substrate includes a holding substrate and a thin film layer formed on the holding substrate, and the protuberant portion is formed in the thin film layer.

7. An optical modulation device comprising:
the optical waveguide device according to claim 1;
a case accommodating the optical waveguide device; and
an optical fiber through which a light wave is input into the optical waveguide or output from the optical waveguide.

8. The optical modulation device according to claim 7,
wherein a control electrode (not illustrated) is a modulation electrode for modulating the light wave propagating through the optical waveguide, and
an electronic circuit that amplifies a modulation signal to be input into the modulation electrode is provided inside the case.

9. An optical transmission apparatus comprising:
the optical modulation device according to claim 8;
a light source that inputs a light wave into the optical modulation device; and
an electronic circuit that outputs a modulation signal to the optical modulation device.
